(19) United States
(12) Patent Application Publication
(10) Pub. No.: US 2026/0133215 A1
(43) Pub. Date: May 14, 2026

(54) Planar Motor Transport and System for Scalable, Multi-Purpose Lab Automation with Distributed Control Architecture and Temporal Reservation Management

(71) Applicant: Lab Sync Inc., San Diego, CA (US)

(72) Inventors: Imad Basila Mansour, San Diego, CA (US); Jonathan David Dambman, San Diego, CA (US); Stephen Paul Testen, Poway, CA (US); Jeffrey Lee Martin, Murrieta, CA (US)

(73) Assignee: Lab Sync Inc., San Diego, CA (US)

(21) Appl. No.: 19/385,776

(22) Filed: Nov. 11, 2025

Related U.S. Application Data
(60) Provisional application No. 63/718,918, filed on Nov. 11, 2024.
(60) Provisional application No. 63/718,925, filed on Nov. 11, 2024.

(51) Int. Cl. G01N 35/04; G01N 35/10

(52) U.S. Cl. CPC G01N 35/04; G01N 35/1002; G01N 2035/0477

(57) ABSTRACT

A framework provides an integration of a system for a planar motor transport with laboratory equipment for performing multiple automated laboratory functions directly within the same operating environment. The framework includes a distributed control architecture and processes for performing workflow agent execution logic, and transport and execute of devices and movers for performing automated workflows with workflow agents. Together the integration of the system for planar motor transport with the distributed control architecture and associated processes enable functions such as combining liquid handling operations, sample access operations, cleanup and recovery operations, and others into a single, scalable platform.

This application is a 35 U.S.C. § 111 patent application that claims the benefit of priority and is entitled to the filing date pursuant to 35 U.S.C. § 119(e) of U.S. Provisional Patent Application 63/718,918, filed Nov. 11, 2024 and of U.S. Provisional Patent Application 63/718,925, filed Nov. 11, 2024, the contents of each of which are hereby incorporated by reference in their entirety.

### FIELD

The present invention relates to the field of automated laboratory processes. Specifically, the present invention relates to planar motor systems for laboratory automation functionality, and to various aspects of automated laboratory processes that are enabled and/or improved by integrating planar motor systems together with a distributed control architecture.

### BACKGROUND

Traditional laboratory automation systems rely heavily on robotic equipment for transporting sample carriers between various independent devices, such as for example robotic arms. These laboratory automation systems are often constrained by the limited throughput of such robotic arms, as the need for repetitive pick-and-place operations increases the risk of sample misalignment, being dropped, spilled, or even damaged during transport. Furthermore, robotic arms are inherently single-function devices, meaning they can only handle one sample at a time. This limitation slows down the overall throughput, making these systems unsuitable for high-throughput environments where many samples need to be processed in parallel. In the existing art, expanding or upgrading traditional robotic systems is costly and often requires significant reconfiguration of the entire laboratory setup. This inflexibility makes it difficult for laboratories to scale up their operations in a cost-effective manner.

Typically, such traditional laboratory automation systems further rely upon conveyor systems to transport specimens, samples, and equipment between different processing stations to streamline workflow and reduce manual handling. Conveyor systems utilize underlying tracks and mechanical devices that follow fixed and limited paths with little flexibility, and often have difficulties with variances in sample types and equipment, as well as maintaining time constraints and scaling throughput.

Planar motors are an emerging field with significant potential to revolutionize automation workflows across various industries. Unlike traditional conveyor systems, this technology provides a flexible, contactless means of moving carriages (movers) over flat surfaces (stators) in multiple directions with high precision. This allows for more dynamic and adaptable automation solutions compared to fixed-path systems. Despite this, planar motors have not yet enjoyed widespread adoption, particularly for laboratory automation, at least because of limitations in managing events such as spills, dropped items, debris accumulation, and equipment malfunctions on processing surfaces. These issues can lead to processing errors, equipment downtime, and increased operational costs, hindering the broader implementation of planar motors.

Therefore, there is a need in the existing art for an integrated system that enhances planar motor technology, at least by providing automated detection and resolution of operational issues. Such an integrated system should be adaptable to any automated application that utilizes planar motors to enable a transformation of workflows across multiple industries.

### SUMMARY

The present invention provides a novel approach to addressing the limitations of traditional robotic systems, particularly in laboratory environments, by introducing a planar motor transport that integrates multiple laboratory functions directly on the same platform and within the same system. This integration occurs within a framework that includes a distributed control architecture and associated processes that together enable functions such as combining liquid handling operations (e.g., pipetting, reagent dispensing, plate washing) and sample access operations (e.g., lidding/de-lidding, capping/de-capping, plate stacking/de-stacking) into a single, scalable platform, and further enables realization of other significant performance improvements over traditional systems.

The distributed control architecture enables a workflow management system that coordinates multiple concurrent laboratory processes while maintaining identical timing requirements across samples within each workflow in a time-based reservation management system for conducting automated laboratory workflows using the planar motor transport, and which enables and autonomous execution layer for coordinating individual workflow instances from initiation through completion in workflow agents, where such agents perform workflows such as manage recipe execution, resource acquisition, and timing coordination while operating within temporal constraints and system-wide scheduling.

Planar motor systems offer a modular and scalable transport design that allows users to easily add or remove devices to accommodate new requirements or increase production capacity, making it adaptable to various laboratory needs In one aspect of the framework of the present invention, integration of planar motor systems provides enables direct, in-situ execution of critical laboratory operations, including liquid handling and sample access tasks, all of which take place directly on the planar motor surface. The design eliminates the need for offloading sample carriers to separate devices, reducing the number of sample transfers and handling steps. This, in turn, minimizes potential failures and increases operational efficiency.

One aspect of the present invention is a cleanup and recovery system designed to integrate with processing elements of a plana motor transport on planar motor surfaces in any automated application to provide several enhancements to laboratory automation functionality. These enhancements, described further herein, collectively provide a comprehensive solution that operates alongside planar motor systems to automatically detect and resolve issues such as spills, dropped items, debris, and equipment malfunctions. The cleanup and recovery improves efficiency, reduces downtime, and maintains optimal operational conditions across a range of automated applications including manufacturing, logistics, warehousing, and laboratory automation.

It is therefore one objective of the present invention to provide systems and methods for improvements in automation of laboratory functions. It is another objective to provide systems and methods for improving the performance of traditional robotic systems, particularly in laboratory environments. It is still a further objective of the present invention to provide a planar motor transport for use in laboratory environments that integrates multiple laboratory functions, and enables automation of those functions, directly within a common operating platform. It is yet another objective of the present invention to provide systems and methods that integrate planar motor systems for automated laboratory functions within a distributed control architecture that at least enables a workflow management system. It is still another objective of the present invention to provide systems and methods that enables an autonomous execution layer within the distributed control architecture responsible for coordinating individual agentic workflow instances from initiation through to completion.

Other objectives, embodiments, features and advantages of the present invention will become apparent from the following description of the embodiments, taken together with the accompanying drawings, which illustrate, by way of example, the principles of the invention.

### BRIEF DESCRIPTION OF THE DRAWINGS

The accompanying drawings, which are incorporated in and constitute a part of this specification, illustrate aspects of the disclosed subject matter in at least one of its exemplary embodiments, which are further defined in detail in the following description. Features, elements, and aspects of the disclosure are referenced by numerals with like numerals in different drawings representing the same, equivalent, or similar features, elements, or aspects, in accordance with one or more embodiments. The drawings are not necessarily to scale, emphasis instead being placed upon illustrating the principles herein described and provided by exemplary embodiments of the invention. In such drawings:

FIG. 1 is a flow diagram of a distributed control architecture according to one aspect of the present invention;

FIG. 2 is a flow diagram of workflow agent execution logic in the distributed control architecture of FIG. 1, according to a further aspect of the present invention;

FIG. 3 is a flow diagram of a transport and execute process in the distributed control architecture of FIG. 1, according to another aspect of the present invention;

FIGS. 4A-4D illustrate diagrams for an in-situ pipetting system in accordance with one embodiment of the present invention with FIG. 4A showing front, top right perspective view of the in-situ pipetting system; FIG. 4B showing a magnification view of the in-situ pipetting system; FIG. 4C showing a front elevational view of the in-situ pipetting system; and FIG. 4D showing a right side elevational view of the in-situ pipetting system;

FIGS. 5A-5D illustrate diagrams for bulk reagent dispensing system in accordance with another embodiment of the present invention with FIG. 5A showing front, top right perspective view of the bulk reagent dispensing system; FIG. 5B showing a magnification view of the bulk reagent dispensing system; FIG. 5C showing a front elevational view of the bulk reagent dispensing system; and FIG. 5D showing a right side elevational view of the bulk reagent dispensing system;

FIG. 6 is a front, top, right perspective view of a deployment of a planar motor system in a laboratory automation environment for cleanup and recovery operations, according to a further embodiment of the present invention; and

FIG. 7 is a right side elevational view of the deployment of a planar motor system in a laboratory automation environment for cleanup and recovery operations as in FIG. 6.

### DETAILED DESCRIPTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

The present invention provides a framework for performing operations in a laboratory environment in which equipment is integrated with a planar motor system that enables the equipment to perform multiple laboratory functions directly on the same platform, and along a system of pathways that are much more complex and robust than with traditional, conveyor or track-based systems on which such robotic equipment is configured. The present invention is performed within one or more systems and/or methods, that include several processing elements each of which define distinct activities and functions that together integrate a planar motor system with a distributed control architecture and processes for performing the workflow agent execution logic and transport and execute of workflows and workflow agents that are embodied therein. It is to be understood that the terms “planar motor transport” and “planar motor system” as used in the present specification may be interchangeably used, and may also be referred to in the industry as a planar robotics system, or planar drive system, and the like.

Planar motors utilize magnetic forces to precisely levitate and move payloads, such as lab plates and samples in a laboratory environment, across a two-dimensional planar motor surface. A planar motor system has modular tiles, or stators, that form a flat surface that forms a fixed two-dimensional matrix of electromagnets or permanent magnets. These magnets are positioned just below the planar motor surface, and allow carriers that have their own sets of magnets to move on the surface. As they are wirelessly propelled and hovered or levitated, they can be precisely controlled with up to six degrees of freedom, meaning multi-directional movement in the x-axis, and y-axis, as well as plus roll, pitch, and yaw in the z-axis.

The planar motor transport that forms a part of the present invention is modular and can be deployed in multiple laboratory (and non-laboratory) use cases. For example, a planar motor transport may be used where sample carriers are moved across a planar motor surface via electromagnetic shuttles. Each shuttle provides six degrees of freedom, allowing for precise positioning and orientation of sample carriers. Unlike traditional systems that rely on robotic arms for transferring sample carriers between devices, the present invention eliminates the need for offloading to equipment on a separate conveyor or track, by integrating all liquid handling and sample access operations directly on a planar motor surface.

The present invention, as noted above, includes a distributed control architecture that serves at least in part as an electronic control system and further includes multiple processes for performing this electronic control system, and dynamically varies the magnetic fields in the stators. This interaction creates a continuously changing magnetic force that levitates the carriers to hover a tiny distance above the planar motor surface, and propels the carriers along defined paths. This distributed control architecture enables precise control of each carrier to ensure they follow their correct path and avoid collisions. Laboratory equipment may be mounted on each carrier, and moved from station to station, or to other equipment mounted on additional carriers.

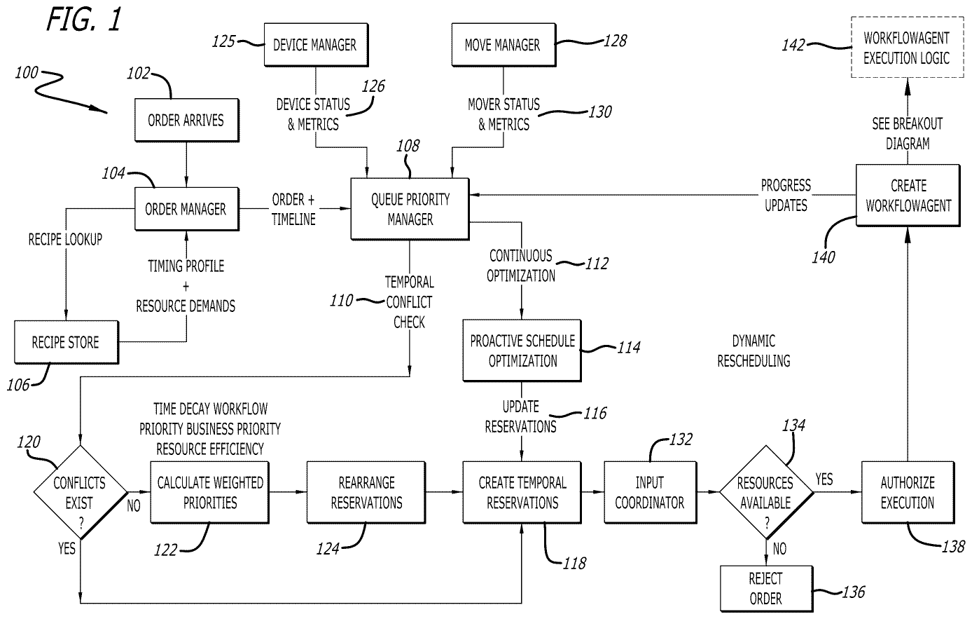

FIG. 1 is a diagram of such a distributed control architecture 100, illustrating a process for a time-based device reservation management system that controls activities in an operating environment (such as for example a laboratory environment with automated functionalities) involving planar motor transports. The distributed control architecture 100 is embodied within one or more systems and/or methods that are performed in a plurality of data processing elements that are components within a computing environment that also includes one or more processors and a plurality of software applications and hardware devices or other components. The one or more processors and the plurality of software applications and hardware devices or other components are configured to execute program instructions or routines to perform the elements, components, modules, algorithms, and data processing functions described herein, and embodied within the plurality of data processing elements.

In FIG. 1, when an order 102 arrives, an order manager 104 performs a recipe lookup from a recipe store 106 and integrates a timing profile and resource demands to create a timeline for the order, and sends that information to a queue priority manager 108. The queue priority manager 108 performs a temporal conflict check 110, and continuous optimization 112 for an order 102. The continuous optimization 112 is performed to ensure proactive schedule optimization 114 for the order 102, and to update reservations 116 and create temporal reservations 118 for in a dynamic rescheduling aspect of the time-based device reservation management system aspect of the distributed control architecture 100.

If no conflict exists at 120, the distributed control architecture 100 creates temporal reservations 118. If there is a conflict at 120, the distributed control architecture 100 resolves the conflict(s) by calculating weighted priorities 122. These priorities weighted priorities 122 are based at least on aspects of the order 102 such as time decay urgency, workflow priority, business priority, and resource efficiency. The distributed control architecture 100 then rearranges reservations 124 in response to the calculation of weighted priorities 122, and then proceeds with temporal reservations 118 once the conflicts are resolved.

The queue priority manager 108 also accepts and integrates as input data information from a device manager 125 (at least with device status and metrics 126 information), and from a mover manager 128 (at least with mover status and metrics information 130). These additional inputs are also used for temporal conflict checks 110, and continuous optimization 112 for an order 102.

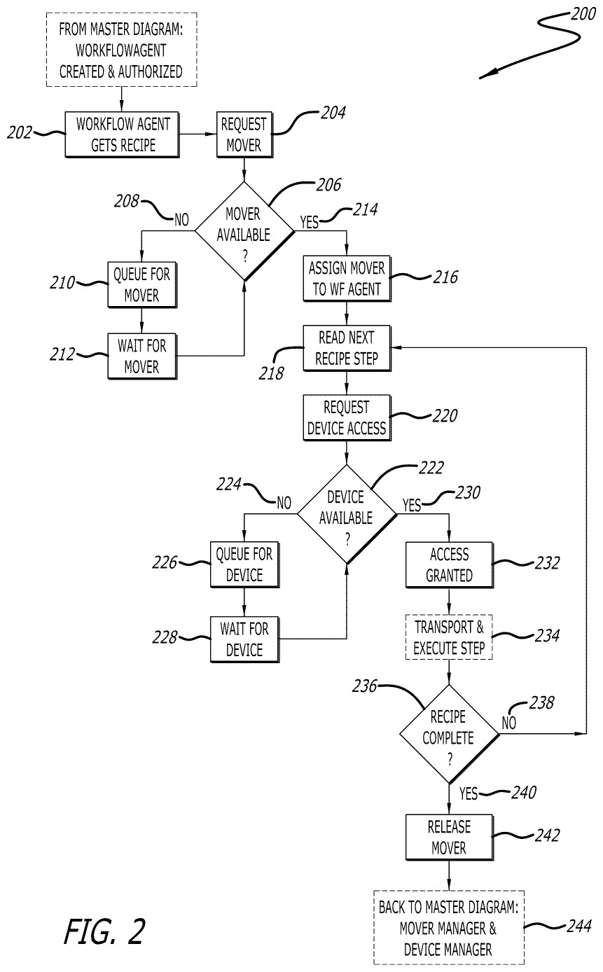

Once the process of dynamic rescheduling is complete, the distributed control architecture 100 then passes all information to an input coordinator 132, which performs a check to ensure that resources are available 134 to complete the order 102. If resources are not available, the distributed control architecture 100 rejects 136 the order 102. If they are available, the distributed control architecture 100 authorizes execution 138 of the order 102. The distributed control architecture 100 then proceeds with creation of a workflow agent 140, and initiates workflow agent execution logic 142. This workflow agent execution logic 142 is shown in further detail in FIG. 2.

The distributed control architecture 100 of FIG. 1 enables multiple concurrent laboratory workflows to operate with guaranteed timing consistency while optimizing overall system throughput through predictive temporal scheduling and coordinated resource management. The distributed control architecture 100 includes several components, features, and capabilities as described further herein that enables these aspects thereof.

The distributed control architecture 100 of FIG. 1 may be thought of as a component coordination framework that includes an order processing layer. The order manager 104 receives batch processing requests specifying workflow type, sample count, and execution parameters. The recipe store 106 is queried to retrieve complete workflow definitions. These include sequential processing steps (device operations, incubation periods, movement requirements), timing specifications (tact time intervals, incubation duration, tolerance windows), resource requirements (device types, processing capabilities, duration estimates), and execution parameters (staggered vs batch processing, priority levels).

The distributed control architecture 100 also includes a temporal scheduling layer. The queue priority manager 108 implements a predictive scheduling system that creates temporal reservations 118 for future resource usage. This includes timeline projection, wherein the distributed control architecture 100 calculates a complete resource demand timeline for entire workflow duration. It also includes a conflict detection function, which identifies temporal overlaps between concurrent workflow resource requirements, and a priority resolution function, which applies a weighted scoring algorithm that calculates weighted priorities 122 and considers, as noted above, time decay urgency, workflow priority, resource efficiency, and other metrics such as system health. The temporal scheduling layer also performs additional functions, such as creating temporal reservations 118, which establishes time-blocked resource allocations with one-minute granularity, and proactive schedule optimization 114, which continuously rearranges future reservations 124 to improve system-wide performance.

The distributed control architecture 100 also includes a resource coordination implementation. Before workflow execution authorization, the input coordinator 132 verifies immediate startup requirements in a validation function. This include verifying mover availability for workflow initiation, starting station accessibility and operational status, a system health verification (PLC connectivity, device operational status), and temporal reservation validation against a current system state.

The device manager 125 and mover manager 128 act as resource providers responding to workflow agent requests to perform distributed resource management in the distributed control architecture 100. Distributed resource management performed by the device manager 125 and mover manager 128 include pool management, for tracking an availability status of movers and devices, and capability mapping for matching resource requests to appropriate available resources. The device manager 125 and mover manager 128 also provide status reporting for analyzing real-time utilization and performance metrics to the queue priority manager 108. The device manager 125 and mover manager 128 also enable an allocation response in distributed resource management, where temporal reservations 118 are honored within specified tolerance windows.

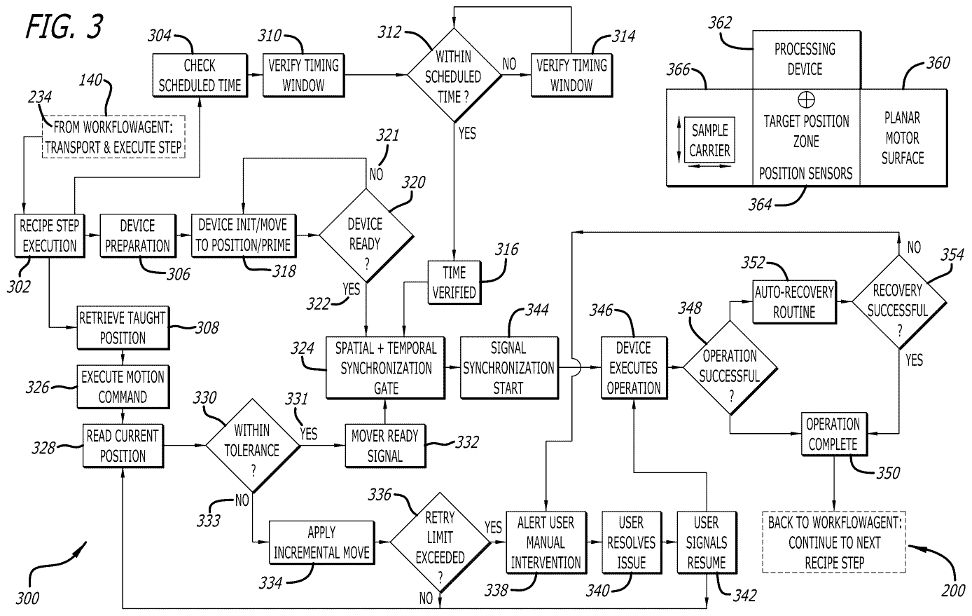

The distributed control architecture 100 in the present invention enables the autonomous execution of workflow agents 140 in the workflow agent execution logic 142 in the architecture illustrated in the process 200 of FIG. 2, and the transport and execute process 300 of FIG. 3.

In the present invention, each workflow agent 140 operates as an autonomous controller for a specific workflow batch for recipe-based execution control. The present invention provides a timing authority by maintaining an internal workflow clock for consistent tact time across all samples. It also manages resource requests, by requesting movers and devices at scheduled times based on temporal reservations 118. The distributed control architecture 100 also coordinates atomic transport execute operations for each recipe step (step coordination), and enables progress reporting for reports on workflow status and timing performance to the queue priority manager 108.

The distributed control architecture 100 also enables distributed decision making. Workflow agents 140 make autonomous execution decisions within a framework of temporal reservations 118 in the time-based device reservation management system aspect of the present invention. For example, the present invention enables resource timing, where the time-based device reservation management system requests resources at predetermined time intervals, as well as error handling for managing step-level failures through atomic operation error protocols. The distributed control architecture 100 also monitors workflow progression as workflow agents 140 advance through recipe steps for operation completion, and ensure timing compliance by monitoring and maintaining specified tact time intervals regardless of minor resource delays.

The time-based device reservation management system embodied in the distributed control architecture 100 provides, in one embodiment thereof, a temporal coordination methodology, in which the present invention manages temporal coordination at workflow level rather than individual sample level. This is accomplished by workflow-level scheduling, where for example all samples within a particular workflow follow an identical batch timing pattern. Staggered execution is also possible, where individual samples start processing with controlled time delays. Temporal reservations 118 also provide resource windows to ensure device availability during required time periods, and tolerance management in which acceptable timing variations (±30 seconds) enable scheduling flexibility.

The temporal coordination methodology also enables parallel workflow coordination, multiple concurrent workflows operate through temporal reservation conflict resolution. This includes resource sharing, where multiple workflows share devices through time-multiplexed access and priority arbitration, where a weighted priority system resolves resource conflicts Parallel workflow coordination and conflict resolution therein also includes timing preservation, where each workflow maintains internal timing consistency despite resource sharing. The temporal coordination methodology also enables scalability, in that the present invention supports 100+ concurrent workflows through workflow-level management.

The distributed control architecture 100 also includes, a further embodiment of the present invention, a feedback and optimization architecture that provides real-time system intelligence. The queue priority manager 108 receives continuous feedback for optimization through, for example, progress monitoring of workflow agents 140, where each workflow agent 140 reports actual vs predicted timing performance.

Real-time system intelligence also occurs through resource utilization, where the device manager 125 reports equipment usage patterns and bottlenecks. Performance metrics are also enabled, for example where the mover manager 128 provides transport timing and efficiency data, and overall system health, via various device and mover indicators and error frequencies.

Still further, the distributed control architecture 100 also includes, a yet another embodiment of the present invention, adaptive scheduling optimization. In this embodiment, the distributed control architecture 100 continuously improves scheduling decisions through performance feedback. This includes timing adjustment by refining future workflow timing estimates based on actual performance, and resource recommendations, by generating hardware optimization suggestions based on utilization patterns. Adaptive scheduling optimization also performs conflict prediction by identifying potential future resource conflicts before they occur, and load balancing, by redistributing workflow scheduling to optimize system-wide throughput.

Implementations of temporal reservations 118 are implemented in the distributed control

architecture 100 include several features. One such feature is granularity, where one-minute time blocks are utilized for resource allocation. Another is scope, where workflow-level reservations cover the entire processing duration. Still further, flexibility is another feature of temporal reservations 118 through tolerance windows that enable minor timing adjustments, and persistence, where temporal reservations 118 are maintained through system state changes.

The distributed control architecture 100 includes a priority resolution algorithm. This algorithm provides a weighted scoring system for resource conflict resolution, using for example time decay factors with increasing priority as samples approach critical timing limits. The algorithm accounts for workflow characteristics, such as priority levels, batch sizes, and complexity factors, as well as resource efficiency through device utilization optimization and mover positioning efficiency. The priority resolution algorithm also accounts for system health by including weights in its scoring system for error recovery and queue backlog prevention.

The distributed control architecture 100 further includes a communication architecture. The communication architecture provides for status reporting and enables real-time feedback from all system components to the queue priority manager 108. The communication architecture also provides command distribution for workflow agent 140 resource requests to appropriate managers, and error escalation through unified error reporting and user intervention protocols.. The communication architecture further provides performance monitoring for orders 102 and recipes 202 with continuous system performance data collection and analysis.

The distributed control architecture 100 also enables scalability and analytics for performance characteristics. This includes concurrent operation capacity for workflow management through system support for hundreds of concurrent workflows, resource coordination through the system for temporal reservations 118 that scales with additional devices, timing precision by maintaining tact time consistency across all concurrent operations, and performance monitoring through real-time tracking of system-wide performance metrics as noted above.

System response characteristics that are possible within the distributed control architecture 100 include scheduling latency, with immediate temporal conflict resolution and reservation creation, and resource allocation with sub-second response to resource requests from workflow agents 140. Additional system response characteristics include error recovery with automatic retry mechanisms with user intervention escalation, and optimization frequency with continuous proactive schedule rearrangement.

FIG. 2 as noted above illustrates a process 200 for performing the workflow agent execution logic 142 within the distributed control architecture 100 of FIG. 1. In the process 200, a workflow agent 140 receives a recipe 202 and requests a mover allocation 204, and determines whether a mover is available at 206. If a mover is not available at 208, a queue 210 for a mover is created, and the process 200 waits for an available mover at 212.

If a mover is available at 214, the process 200 assigns a mover at 216 to a workflow agent 140, and begins a recipe execution loop. The process 200 reads 218 the next step in the recipe 202 for the order 102, and requests device access at 220. The process 200 then determines if the device is available at 222. If the device itself is not available at 224, the process 200 queues for the device at 226, and waits for its availability at 228 If the device is available at 230, access is granted at 232, and the process 200 begins to execute a transport and execute step(s) at 234. The process 200 then determines if the recipe is complete at 236, and if not at 238 it returns to read the next recipe step at 218. If the recipe is complete at 240, it releases the mover(s) at 242 and returns 244 to the distributed control architecture 100.

This workflow agent execution logic 142 in process 200, together with the distributed control architecture 100 of FIG. 1, enables several features of the present invention that enhance the performance of automated laboratory functionality using planar motor systems. These include simplified availability checking to determine whether movers and devices are available immediately or a queue needs to be formed, and a FIFO (first in first out) queuing system for resource conflicts. Also, a single autonomous controller is utilized, such that only a workflow agent 140 makes resource requests. The present invention also enables parallel operation, where multiple workflow agents 140 can operate simultaneously without conflicts. This enables many concurrent sample processing workflows through coordinated resource sharing.

The process 200 of FIG. 2 illustrates, as noted above, a workflow agent execution logic 142 that provides an execution layer for enabling autonomous workflow management while maintaining coordination with system-wide resource management and temporal scheduling, and supporting reliable concurrent execution of multiple laboratory workflows. The following technical details explain this autonomous workflow execution layer embodied in the process 200 of FIG. 2.

Workflow agents 140 are represented and performed pursuant to this autonomous workflow execution layer, which is responsible for coordinating individual workflow instances from initiation through completion. The following explanation includes technical implementation details of how workflow agents 140 manage recipe execution, resource acquisition, and timing coordination while operating within the framework of temporal reservations 118 and system-wide scheduling.

The autonomous workflow execution layer features recipe-based control for workflow agents 140. Upon authorization from the input coordinator 132, a workflow agent 140 is instantiated with a recipe definition, which provides a complete workflow specification including sequential steps, timing requirements, and resource needs. A workflow agent 140 is also instantiated with temporal reservations 118, which are pre-allocated time windows for device access throughout workflow duration. Recipe-based control in the autonomous workflow execution layer also includes sample identification with specific sample carrier assignment and tracking information, and execution parameters, such as whether to perform a batch vs staggered processing mode, and priority level and tolerance specifications.

Recipe-based control within the autonomous workflow execution layer also includes recipe step management. Each workflow agent 140 maintains internal state tracking for recipe progression, including current step index (for the position within sequential recipe step list), and step parameters (including device requirements, operation specifications, and timing constraints for active step). Each workflow agent 140 also provides a completion status in a step-by-step execution progress and timing performance, and provides error context in step-level error states with reporting on recovery attempts.

The process 200, and the associated autonomous workflow execution layer, also feature a resource acquisition protocol. The resource acquisition protocol governs mover resource management, where a workflow agent 140 initiates mover resource acquisition through a standardized request protocol. This standardized request protocol includes an availability check, where a query mover manager provides information about available movers matching workflow requirements, and an assignment request where specific mover allocation(s) are requested for a workflow duration.

The resource acquisition protocol also performs queue management, where the protocol allows the workflow agent 140 to enter a mover allocation queue if no resources are immediately available, and includes a wait protocol that maintains a position in the queue 210 until a mover becomes available. The resource acquisition protocol also includes assignment confirmation, where the workflow agent 140 receives a mover allocation and the process 200 establishes a control relationship over the allocated mover(s).

The autonomous workflow execution layer of the process 200 also enables device resource coordination. This means that device access follows a similar acquisition pattern with temporal awareness. With device resource coordination, the autonomous workflow execution layer provides for step-based requests for device access for specific recipe step execution. It also provides for temporal validation, where the process 200 verifies request timing against pre-established temporal reservations 118. Additional features include availability verification to confirm a device's operational status and readiness, access queuing for device access queues where temporal windows are not yet reached, and access granting, where the process 200 receives device access authorization and proceeds to operation execution.

The autonomous workflow execution layer of the process 200 also enables recipe step execution 302 coordination, in iterative step processing, where a workflow agent 140 executes recipe steps 302 through controlled iteration. This includes step retrieval, where the workflow agent 140 reads next step specifications from a recipe definition, and resource evaluation, where the workflow agent 140 identifies required resources (such as mover position, device access, timing requirements). Recipe step execution 302 coordination also includes an atomic operation trigger, where the process 200 initiates the transport and execute process 300 for a current step in a recipe 202, completion monitoring where the process 200 monitors atomic operation progress and completion status, and progress advancement, where the process 200 increment the workflow agent 140 to the next step in the recipe 202 upon successful completion.

The autonomous workflow execution layer of the process 200 further enables the transport and execute integration that is performed in the process 300 of FIG. 3. Each recipe step execution 302 delegates to an atomic transport and execute operation that includes operation handoff, where control is transferred to integrated operation coordination, and parameter specification where step-specific parameters are provided (for example, regarding target device, operation type, and timing requirements). Transport and execute integration also include completion waiting, where atomic operation is monitored for success/failure completion, and result processing for handling of operation results and determining workflow progression.

The autonomous workflow execution layer of the process 200 additionally enables a workflow completion and resource release protocol. The process 200 monitors for workflow agent 140 completion through step progression in a recipe completion detection algorithm. This includes step count verification, in which the recipe completion detection algorithm compares a current step index against a total recipe step count. Completion criteria are accounted for by verifying that all required operations completed successfully. The recipe completion detection performs a final state assessment, where the process 200 confirms that workflow objectives have been achieved. Finally, the recipe completion detection algorithm performs completion signaling by reporting workflow completion to a system coordination layer.

Upon workflow completion, each workflow agent 140 releases all allocated resources in a resource deallocation protocol. This includes mover release, where the process 200 returns movers to the available pool through the mover manager 128. The resource deallocation protocol also includes device cleanup to ensure all device operations are properly terminated and devices are released for availability. The resource deallocation protocol also performs a temporal reservation closure that signals completion of reserved time windows, and a system notification that reports resource availability to the queue priority manager 108 for optimization.

The autonomous workflow execution layer also includes an error handling and recovery architecture. This error handling and recovery architecture performs step-level error management, where each workflow agent 140 handles errors occurring during recipe step execution. This includes error detection, by monitoring atomic operation status for failure conditions, and recovery assessment by evaluating an error type and determining recovery options. The error handling and recovery architecture also includes a retry protocol that implements step retry logic for recoverable errors, and assesses escalation criteria to identify non-recoverable errors requiring external intervention. The error handling and recovery architecture also includes steps for workflow preservation to maintain a workflow state during error resolution.

The error handling and recovery architecture also manages resource failure response. Resource-related failures trigger specific response protocols, including mover failure protocols for handling transport system errors and positioning problems, and device failure protocols for managing device operational errors and recovery attempts. Other specific response protocols include those for timing violations to address temporal reservation conflicts and scheduling issues, and communication failures to handle system communication errors and retry mechanisms.

The autonomous workflow execution layer also implements one or more protocols for timing coordination. An internal workflow clock maintains a timing state for each workflow agent 140 for tact time consistency. This monitors a workflow start time by recording a workflow initiation timestamp, and includes step timing tracking for monitoring actual vs expected timing for each recipe step. The internal workflow clock also performs tact time enforcement to ensure consistent timing intervals between samples within a workflow, and timing variance monitoring for tracking and reporting of timing deviations from expected performance.

The autonomous workflow execution layer also includes temporal reservation 118 integration. Operations for workflow agents 140 are coordinated with system-wide temporal scheduling through reservation awareness with knowledge of pre-allocated device access time windows. Workflow agents 140 also exhibit timing compliance by executing operations within reserved time periods, and follow scheduling coordination with the queue priority manager 108 for timing optimization. Workflow agents 140 also have variance reporting for actual timing performance for system learning and optimization.

The autonomous workflow execution layer also includes communication and coordination protocols. Through a system integration interface, workflow agents 140 communicate with system components through defined protocols that enable resource managers to request and release resources through the device manager 125 and the mover manager 128. These protocols also enable the queue priority manager 108 to report progress and receive timing coordination information, and enable both error reporting through communication of error states and resolution status to system monitoring, and status updates that provide real-time workflow progress information.

These communication and coordination protocols also enables a progress reporting architecture for continuous workflow monitoring through structured reporting. This includes step completion reporting, where the system is notified of recipe step completion and timing, and generation of resource utilization data to report actual resource usage patterns and performance. It further includes error frequency tracking that provides error statistics for system optimization, and performance metrics that supply timing and efficiency data for system analysis.

Technical implementation of the autonomous workflow execution layer is realized through a state management architecture that provides for execution control flow and includes coordination mechanisms. The state management architecture provides for states such as recipe state (current step index, parameters, completion status) and a resource state (allocated movers, device access grants, timing reservations. The state management architecture also provides for an error state (active errors, recovery attempts, escalation status) and a performance state (timing metrics, resource utilization, progress indicators). These states enable the workflow agent execution logic 142 to execute control flow. This includes initialization of a workflow agent 140, such as recipe loading, resource acquisition, and temporal verification, and iteration control through step-by-step execution with completion verification. Execution control flow further includes error handling through recovery protocols with workflow preservation priority, and completion processing through resource release and final status reporting. Coordination mechanisms include a request/response protocol that provides for standardized communication with resource managers, event-based signaling that provides for asynchronous notification of state changes and completions, queue management for orderly waiting for resource availability, and timeout handling to provide appropriate responses to resource acquisition delays.

The autonomous workflow execution layer also enables scalability and analytics for performance characteristics. These include concurrent operation support, enabling independent execution for multiple workflow agents 140 to operate without direct interference, and coordinated resource sharing through a management layer. Other scalability and performance characteristics include timing independence, where each workflow maintains internal timing consistency, and system support for numerous concurrent instances of workflow agents 140.

The autonomous workflow execution layer also enables additional scalability and performance characteristics that provide for execution efficiency. These include resource optimization for efficient resource acquisition and release protocols, and timing precision for accurate tact time maintenance within timing tolerance specifications. Other characteristics for execution efficiency include error recovery for rapid error detection and recovery with minimal workflow disruption, and progress tracking for real-time monitoring of workflow execution status.

FIG. 3 is a diagram of a transport and execute process 300 illustrating the transport and execute step(s) 234 of the workflow agent(s) 140 from the process 200 of FIG. 2. In the transport and execute process 300, recipe step execution 302 involves several initial functions, such as checking scheduled time 304, device preparation 306, and retrieving previously-learned or taught positions 308. For checking scheduled time 304, the transport and execute process 300 verifies a timing window 310, and determines at 312 whether the recipe is within a scheduled time. If it is not, the transport and execute process 300 waits for the scheduled time 314 and continues with determining the scheduled time at 312 until it is within the scheduled time. If it is within the schedule time, timing is verified at 316, and spatial and temporal synchronization 324 commences.

Device preparation 306 involves device initialization 318, and moving the device into position or priming the device for the recipe 202 and order 102. The transport and execute process 300 determines if the device is ready at 320. If it is not ready 321, the transport and execute process 300 returns to the step of device initialization 318. If it is ready 322, spatial and temporal synchronization gate 324 commences.

Retrieving previously-learned or taught positions 308 involves determining whether mover and/or device tolerances are being exceeded for the recipe 202. The process 300 executes motion commands 326, and reads current positions 328, and determines whether the movers and/or devices are within expected tolerances at 330. If they are within expected tolerances at 331, a mover ready signal 332 is issued for the transport and execution loop. If the movers and/or devices are not within expected tolerances at 333, the transport and execute process 300 applies incremental moves 334 and checks again until a retry limit is exceeded at 336. When retry limit is exceeded at 336, the transport and execute process 300 alerts a user for manual intervention at 338, and the user resolves the issue at 340. The user then signals a return 342 to read the current mover and/or device position at 328, and also is able to resume device operation at 346.

If the movers and/or devices are within expected tolerances 330, the transport and execute process 300 sends a signal 332 that the mover and/or device is ready, and this comments the spatial and temporal synchronization step 324. The transport and execute process 300 sends a signal for a synchronized start 344, and the device(s) execute their operations 346. The transport and execute process 300 then determines if the operation was successful at 348. The operation is either complete at 350, or an auto-recovery routine 352 is initiated. At 354, the transport and execute process 300 determines if auto-recovery was successful, and if yes then the operation is complete 350, and the transport and execute process 300 returns to the prior workflow agent process 200 in FIG. 2 for the next step in a recipe 202. If the auto-recovery was not successful at 354, the transport and execute process 300 proceeds to alert a user for manual intervention at 338.

It is to be understood that the functions of retrieving previously-learned or taught positions 308, executing motion commands 326, and reading current positions 328, and the distributed control architecture 100 generally, are all agnostic as to the implementation architecture that governs the underlying planar motor transport provider or technology. In other words, the present invention is configured to work with any external implementation architecture, and therefore the present invention is not to be limited to any particular type of implementation or provider of planar motor transport or system, or robotic technology therein.

In one exemplary implementation, such as for the xPlanar planar motor system provided by Beckhoff, in which both programming languages such as Python are utilized with programming language controllers (PLCs), a path planner function performs route planning and optimization, as well as traffic management and collision avoidance and station entry/exit management. Semantic context update may be utilized to analyze a mover state, in single source of truth, where a physical state (PLC-sourced) is determined using semantic context (Python-generated), along with access control and validation, and localization status. Using Python, a controller provides a hardware communication interface, along with mover state management and synchronization, and motion command execution and validation. The controller enables command execution functions such as writing command parameters to a global variable list (GVL), writing commands to a main PLC, and waiting for completion, allowing for physical state updates to single source of truth for the mover state.

The GVL (Global Variable List) includes global constants (such as the number of movers, number of tiles). Command parameters are defined and exposed in the GVL as well. The main PLC performs functions such as system initialization and command dispatcher, i.e. it listens to Python and continuously updates all function blocks (i.e. keeps them alive). The GVL shares states and parameters with function blocks, where all operational commands are state machines and use same pattern (Idle, Validate, Commanding, Busy, Executing, Done, Error). Function blocks include functions such as Enable/Disable, MoveToPosition, MoveOnTrack, OrbitInPlace, etc.

The transport and execute process 300 of FIG. 3 represents a fundamental unit of operation in an integrated planar motor system for laboratory automation according to the present invention. The following passages provide additional explanation of the operational methodology that enables integrated devices to process samples directly on a planar motor surface 360 without the offloading requirements of traditional robotic laboratory automation systems.

The transport and execute process 300 includes a parallel preparation layer for system coordination. This parallel preparation layer enables initiation of recipe step execution 302, so that when a workflow agent 140 executes a recipe step (e.g., “DE-LIDDER operation at Station 1”), the system initiates three concurrent preparation processes.

These concurrent processes include a spatial positioning process, in which the present invention retrieves pre-stored taught position 308 coordinates from a database. These coordinates specify exact an x, y and z location for a sample carrier relative to integrated device. A planar motor controller 362 executes a motion command to transport the sample carrier to a target position 364, and real-time position feedback is provided to monitor the approach to the target coordinates 366.

A further process involves device preparation. In this process, an integrated device begins a preparation sequence (initialization, purge, prime), and the device executes self-diagnostics and readiness verification. The device then signals its operational status to the system coordinator. Device preparation occurs independently of mover positioning.

A third concurrent process is for temporal verification. In this process, and as noted above, the present invention verifies a current time 310 against a scheduled execution window. The scheduled timing is derived from workflow-level temporal reservations 118. If execution is premature, the overall system waits for a scheduled timing window 314. The timing verification process ensures consistent tact time across workflow samples.

The transport and execute process 300 also includes a position verification protocol by reading the current position 328. This protocol performs tolerance checking as noted above. For example, upon arrival at a target position, the transport and execute process 300 reads actual mover coordinates, and compares the actual position against taught position coordinates. The position verification protocol may have preset tolerance specifications, such as for example ±0.1 mm in each of the x, y and z axes. Regardless, position verification in this protocol occurs before any device operation on the planar motor surface.

The position verification protocol also performs a correction sequence as indicated further at 366. If a position exceeds a tolerance, the transport and execute process 300 calculates an incremental correction move 334. Once this is executed and the position is re-verified, the protocol repeats until the position falls within a tolerance specification. The retry limit 336 prevents infinite correction loops.

The position verification protocol further monitors for error escalation. If a retry limit 336 is exceeded, the transport and execute process 300 generates one or more alerts user for manual intervention 338. The sample carrier remains in position, with no automatic removal or skip, until a user resolves the positioning issue 340 by obstruction removal, re-enabling, etc. The user then signals 342 the transport and execute process 300 to resume the verification sequence.

The transport and execute process 300 also includes protocol(s) for a synchronization gate implementation 324. These protocols enable a ready signal coordination, in which three independent “ready” signals are required before proceeding. This include a signal that ensures that a mover is positioned 332 within a tolerance specification, a signal that ensures that a device preparation is complete and operational 320, and a signal that ensures that a scheduled execution time window has been achieved 316.

A direct transition protocol for the spatial and temporal synchronization gate implementation 324 ensures that when all three ready signals are confirmed, the present invention immediately signals a synchronized start 344. No additional coordination delays or setup steps are needed, and the present invention begins an immediate transition to device operation execution 346. This synchronized start operations eliminates timing variations between samples.

Device operation execution is further performed in the transport and execute process 300 by operation monitoring and implementation of auto-recovery protocols. In operation monitoring, when a device executes a programmed operation (such as lidding, pipetting, dispensing, etc.), the present invention monitors the operation status through device feedback. Operation completion is signaled by the device to the system coordinator. Any error conditions are detected through device status reporting.

In implementation of auto-recovery protocols, common operational errors trigger automatic recovery routines 352. Recovery attempts include device reset, parameter adjustment, and retry operations. Auto-recovery is limited to predetermined safe operations, and recovery success or failure is reported to the system coordinator.

The transport and execute process 300 also includes a further error handling layer that includes a user intervention protocol. In this protocol, unrecoverable errors escalate to user intervention alerts 338, and the present invention maintains the sample carrier in its current position in such an unrecoverable error. Workflow execution is paused and does not terminate or skip a sample. A user interface provides error context and suggested resolution actions. The error handling layer includes a resume capability where after a manual issue resolution 340, the user signals 342 the transport and execute process 300 to resume. The system re-executes verification sequences (position, device ready, timing), and operation continues from the interruption point. Sample integrity is preserved throughout this error resolution process.

The transport and execute process 300 also includes a timing integration layer for temporal reservation compliance. Each atomic operation executes within pre-calculated time windows that are derived from workflow-level temporal scheduling. Compliance verification prevents premature or delayed execution, and timing consistency is maintained across parallel workflow operations.

The timing integration layer also enables tact time consistency. Identical timing intervals are maintained for all samples in the same workflow. Timing verification at an atomic level supports workflow-level timing guarantees, and parallel workflow operations are coordinated through a temporal reservation system. Individual sample timing variations eliminated through synchronized execution

The transport and execute process 300 also includes a communication architecture that further comprises a software coordination layer. In this layer, the device manager 125 handles device preparation and status communication, and a processing device in a planar motor controller 362 manages positioning commands and feedback. Each workflow agent 140 coordinates its overall atomic operation sequence. Unified error reporting occurs in this layer through software coordination interfaces.

The communication architecture also includes a status reporting protocol. Real-time position feedback is received from the system for planar motor transport, and device readiness and operational status data is received from integrated devices. Error conditions and a recovery status is received through a unified reporting interface. Operation completion confirmation enables workflow progression.

Technical implementation of the transport and execute process is 300 is explained in further detail below. The present invention includes a taught position database, where pre-calibrated coordinates are stored for each device and operation combination. Coordinates are established during a system commissioning process. A grid-based positioning system enables modular device placement, and position accuracy is verified during system validation

A device integration interface is provided to enable standardized communication protocols for device coordination, and device-agnostic operation commands with parameter translation. This enables addition of modular devices without any further system architecture modification. The interface also enables uniform error reporting and status communication across device types.

System performance characteristics include position tolerance of ±0.1 mm repeatability, and incremental moves with verification in a correction sequence. The transport and execute process 300 enables parallel preparation that eliminates sequential setup delays, and includes recovery protocols that preserve sample integrity over throughput optimization.

The integration of systems for planar motor transport for laboratory automation, together with the distributed control architecture 100 and the process 200 for performing the workflow agent execution logic 142 and the transport and execute process 300 embodied therein in the present invention, enable several advantages and use cases as further described in the following paragraphs. One major advantage of the overall system embodied within this framework of the present invention is its ability to support massive parallelism by enabling the simultaneous movement and processing of multiple sample carriers. This parallelism is enabled by the modular tile design and the use of multiple shuttles, which can move independently across the planar motor surface. Each shuttle can transport a sample carrier to different liquid handling or sample access stations without interfering with other shuttles.

By processing all sample carriers concurrently, the present invention drastically reduces takt time, which is the rhythm or pace at which tasks are completed, and thereby increasing throughput. Unlike traditional robotic systems that can only process one sample carrier at a time, the system for planar motor transport the present invention can handle all plates in process concurrently, limited only by the number of shuttles operating on the planar motor surface.

The present invention also provides for scalability and modularity. It is inherently scalable, as it is built from modular square tiles and scientific devices that can be arranged to create platforms of varying sizes and configurations for any kind of laboratory environment, and indeed also operating environments outside of laboratory settings. Users can start with a small-scale system and gradually expand by adding additional tiles and devices as their needs evolve. This modular design ensures that the present invention can grow without requiring costly redesigns or reconfigurations, providing a future-proof automation strategy.

Additionally, the present invention is designed to integrate easily with third-party devices and advanced workflows. Scientific instruments, such as plate readers, centrifuges, and thermal cyclers, can be positioned around or above the planar surface, enabling seamless workflow automation that extends beyond liquid handling and sample access tasks.

The present invention enables many enhancements to automated laboratory functions, and many different use cases as further described herein. For example, the present invention enables direct in-situ liquid handling and sample access operations, by integrating both liquid handling and sample access operations directly onto the planar motor surface. The present invention supports liquid handling operations, such as those involving multi-channel pipettes in pipetting systems. Multi-channel pipettes, or pipette heads, refer to any disposable or non-disposable liquid transfer devices with one or more syringes that can be actuated simultaneously or independently. These devices are used to transfer discrete amounts of liquid from one vessel to another. When mounted adjacent to a planar motor, they enable pipetting operations to take place directly on the surface of the planar motor deck. This eliminates the need to off-load samples via a robot arm to a third-party pipetting system, thereby reducing the risk of harm to the samples and providing significant time savings.

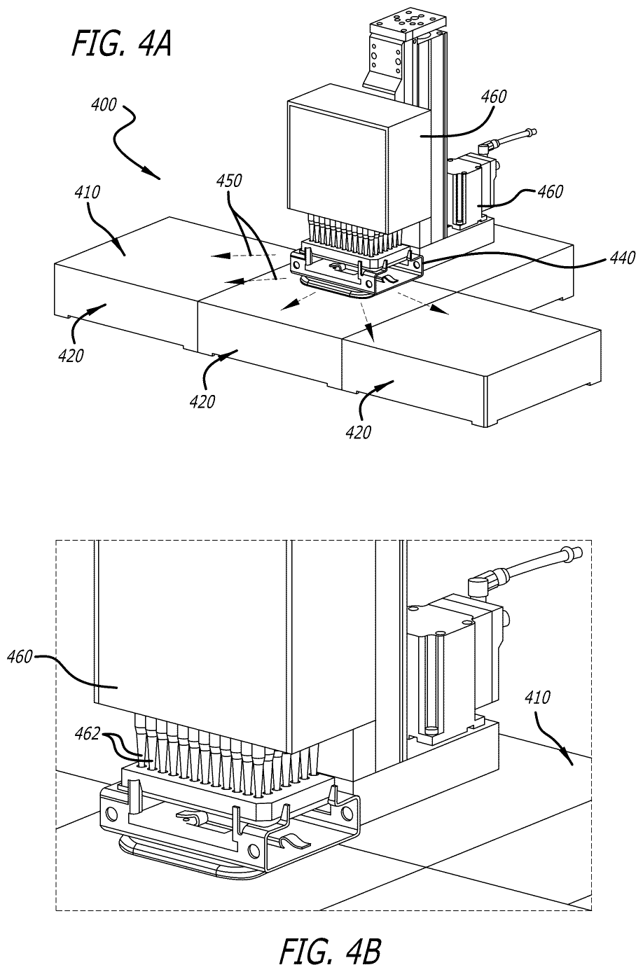

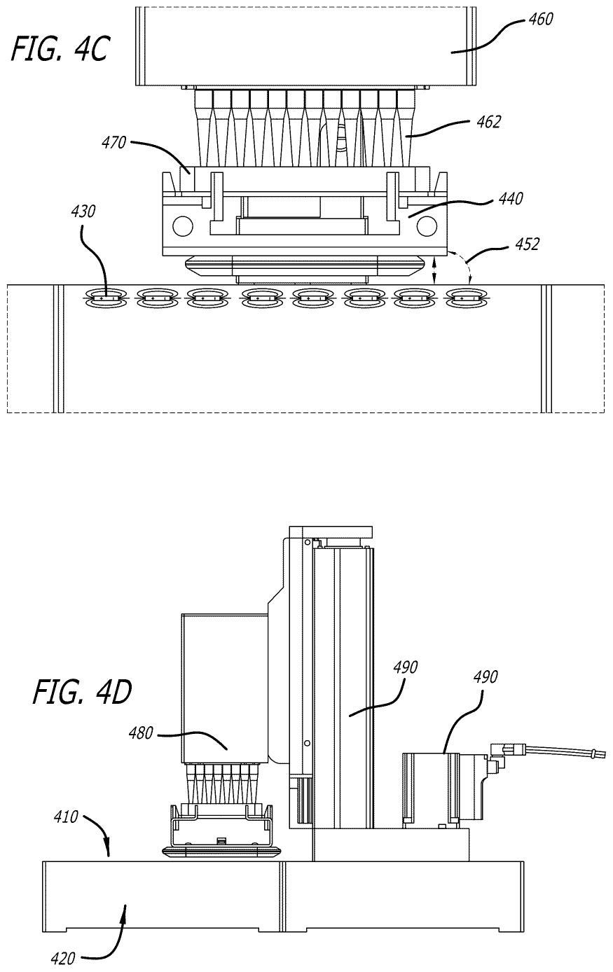

The present invention supports all multi-channel pipetting options; a 96-channel system is depicted in the embodiment of FIGS. 4A-4D. In FIGS. 4A-4D, an in-situ multi-channel pipetting system 400 is integrated with planar motor technology that includes a planar motor surface 410, a plurality of modular planar motor stators 420 (or, tiles), and a plurality of electromagnets or permanent magnets 430. A hovering labware shuttle 440 serves as a planar motor robot or mover and is positioned above the planar motor surface 410 in magnetic levitation due to the stators 420 and magnets 430, and moves in multiple planar directions 450, including roll, pitch and yaw movement in the z-axis 452, as defined by the magnetic fields of the magnets 430.

The in-situ multi-channel pipetting system 400 includes a multi-channel pipetting head 460, and pipette tips 462 that interface with a labware vessel 470. The combined integration of the multi-channel pipetting system 400 with the hovering labware shuttle 440 (the planar motor robot or mover) provides for the in-situ sample processing. As shown in FIGS. 4A-4D, an internal drive device 480 actuates pipette pistons for aspirate and dispense functions, and Z-axis drive 490 provides vertical travel for labware access and pipette tip 462 loading operations.

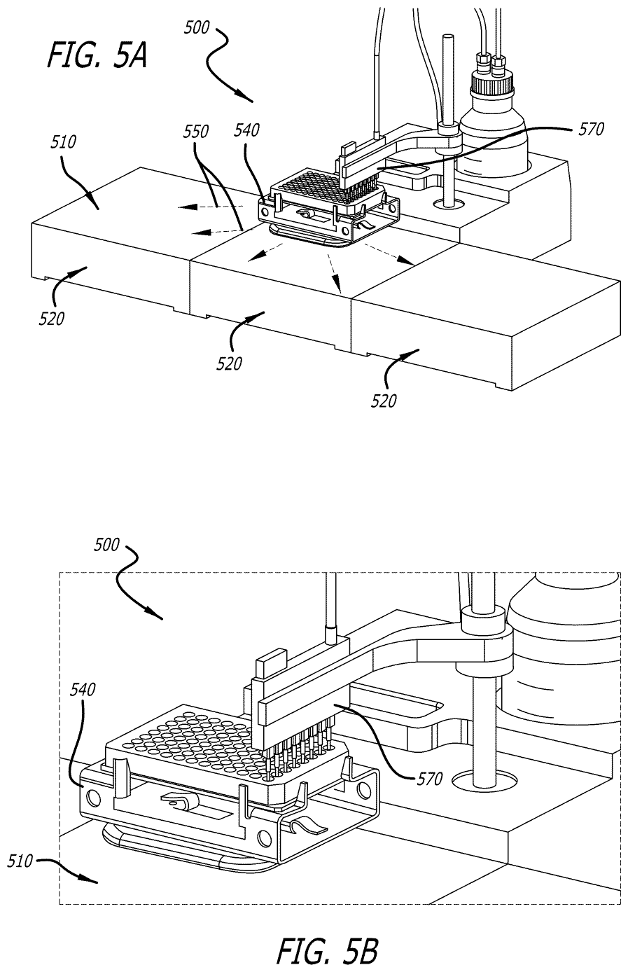

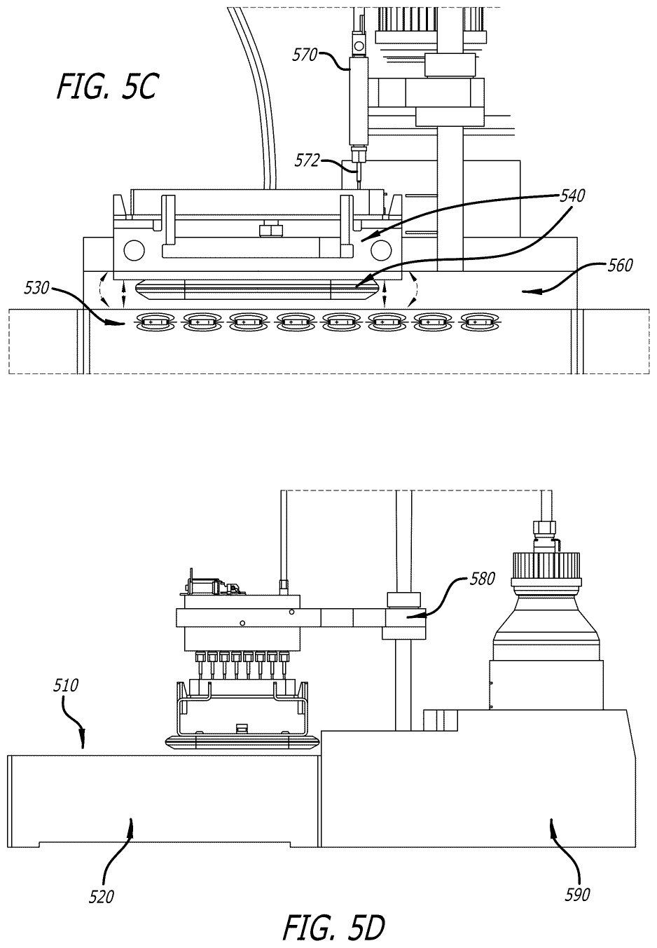

FIGS. 5A-5D illustrates a further embodiment of the present invention, in which a bulk reagent dispenser 500 is positioned above the planar motor surface 510. As with FIGS. 4A-4D, the planar motor system includes a plurality of modular planar motor stators 520 (or, tiles), and a plurality of electromagnets or permanent magnets 530. A hovering labware shuttle 540 serves as a planar motor robot or mover and is positioned above the planar motor surface 510 in magnetic levitation due to the stators 520 and magnets 530, and moves in multiple planar directions 550, as well as in yaw, pitch and roll directions 560, as defined by the magnetic fields of the magnets 530. The stators 520 provide electromagnetic lift and directional control to the hovering labware shuttle 540. This configuration allows for the precise addition of reagents without the need to offload the plates. This improves efficiency and reduces sample transfer time.

In FIGS. 5A-5D, a multi-channel precision dispense head 570 and associated nozzles 572 interface with a labware vessel 574, and the motion of the labware vessel 574 is synchronized with the reagent dispense mechanism comprised of the dispense head 570 and associated nozzles 572. The combined integration of the multi-channel bulk reagent dispenser 500 and the planar motor robot or mover (the hovering labware shuttle 540) enables the in-situ sample processing. After each dispense, the hovering labware shuttle 540 moves incrementally to align to a next series of reaction wells with dispense nozzles 572. A dual-axis drive 580 provides vertical travel to accommodate labware of varying height and rotation to access a waste and purge trough 590.

As noted above, many uses cases are possible, and are within the scope of the present invention. For example, the present invention may be used for acoustic dispensing, which enables precise, contactless transfer of small liquid volumes using acoustic waves. Use of a planar motor system with the distributed control architecture 100 and processes 200 and 300 embodied therein allows for high-speed dispensing and eliminates the need for physical contact with the sample, offering an alternative or complement to conventional pipetting systems.

The present invention may also be deployed with integrated plate washers. This enables plates to be washed and processed directly on the planar motor surface. Sucha deployment eliminates the need to move plates to external washing stations, which reduces the total number of steps in an overall workflow and minimizes handling errors.

Other types of sample access operations that may be performed with the present invention include lidding and de-lidding. The present invention may be integrated in lidding and de-lidding operations to handle the placement and removal of lids on sample plates. Such operations are fully synchronized with other in-situ steps, reducing the need for manual handling and maintaining sample integrity.

The present invention may also be applied to capping and de-capping operations, where vial capping and de-capping systems are integrated with the planar motor system to handle sample containment directly on the planar motor surface. This eliminates the need for offloading to separate capping stations.

The present invention may also be applied to plate sealing and de-sealing systems. In such systems, a thin seal is applied either through heat or adhesive onto sample plates to secure their contents. The present invention may also handle the removal of the seal when necessary, ensuring that sample integrity is maintained while offering an efficient method for sealing plates during or after processing.

The present invention may also be applied to automation of in-situ detection and analysis. Workflow agents 140 may be deployed with planar motor systems in the present invention to enable real-time analysis of samples without the need for offloading to external detection devices. Detection systems integrated with the present invention offer a range of analytical techniques, including workflow agents 140 for fluorescence detection to measure the emission of light from fluorophores within samples. This provides a highly sensitive method for detecting specific biomolecules or reactions. Workflow agents 140 may be deployed within the present invention for luminescence detection to enable the measurement of light emitted by chemical or biological reactions within the sample. This provides an additional method for analyzing processes such as enzyme activity or cellular responses.

The present invention may also be applied to absorption detection to measure the absorption of light as it passes through a sample. This analytical technique provides insights into concentration and purity of compounds, as well as real-time reaction monitoring. The present invention may also be integrated with imaging technologies for visualizing samples in situ. This enables real-time observation and monitoring of cellular, tissue, or organismal behavior, as well as morphological changes during experiments.

Still other analytical techniques are possible and within the scope of the present invention. For example, the present invention may be further integrated with other detection technologies, such as radiometric and light scattering detectors. Such integrations provide a comprehensive platform for a wide range of in-situ sample analysis tasks. Regardless, these detection capabilities allow the present invention to be applied to conduct real-time analysis and monitoring of reactions, cells, and processes directly on the planar motor surface. This produces streamlined workflows and enhanced data accuracy by reducing the need for sample transfers.

The present invention also integrates sample storage and incubation operations directly on the planar motor surface, providing efficient management and environmental control for various sample types. Such operations include automated plate stacking and de-stacking, enabling efficient plate management during workflows without requiring robotic arm interventions. This ensures continuous processing by reducing the need for manual plate handling.

The present invention also enables improved automation of in-situ incubators designed to control environmental conditions (e.g., temperature, humidity, gas concentration) required for the processing and storage of samples, reactants, cells, organoids, tissues, and microorganisms. These incubators maintain optimal conditions throughout the workflow, ensuring that biological and chemical processes occur under proper circumstances without the need to offload plates to external devices.

As is evident from these types of use cases, the present invention is particularly well-suited for applications requiring high-throughput workflows, precise liquid handling, and efficient sample management. Further examples of use cases include high-throughput screening, where parallel processing capabilities enabled by the present invention allow for the rapid screening of large volumes of samples, significantly reducing processing times. Another exemplary use case is ELISA assays, where the present invention streamlines ELISA workflows, reducing the number of pick-and-place steps and increasing the reliability of the process at least due to minimizing the need for robotic arm operations.

Other use cases include diagnostics and clinical testing. The ability to integrate liquid handling and sample access operations on a single platform allows the present invention to be applied for high-throughput diagnostic applications, such as for example COVID-19 testing. Still further, the flexibility and integration provided by the present invention for liquid handling, capping, and dispensing make it well-suited for chemical synthesis workflows that require precise handling of reagents.

In addition to high throughput applications, the present invention is also applicable for high-content screening analyses, such as where imaging systems and cell-based assays are utilized. For example, in addition to integration with third-party detectors and analysis instrumentation, the present invention enables development and implementation of proprietary on-deck analysis modules for planar motor systems. Examples of such on-deck analysis modules include absorbance and fluorescent detection similar to those in standard plate readers and multi-mode plate reading instruments. Similarly, miniaturized, Brightfield and fluorescent imaging modules may be implemented for on deck, high content imaging microscopy or simple Brightfield imaging to monitor analyze end point assays or the status of cell growth or other samples.

Imaging modalities within the present invention may include all modes of Brightfield, epi-fluorescent, confocal, two-photon, and light sheet imaging, all of which are used to analyze cells in 2-D, 3-D or larger, organoid or spheroid cell and tissue models. This may include the use of multi-lands and multi-camera erase modes for any of the imaging modalities to read wells or samples in parallel.

Still further, a further implementation of planar motor system technology with the present invention is in the use the X-Y motion of the moving shuttles for selection of wells or samples for detection or imaging, and the use of modulating a shuttle in Z space for focusing the samples for microscopy applications. Still further, moving a shuttle through the Z axis could be used for taking multiple images of the sample for 3-D imaging. Such examples of proprietary on-deck detection modules greatly simplify and reduce the footprint of all existing on-deck microscopy technology that is used with traditional conveyor systems.

In a further embodiment, the present invention enables improvements in automation of cleanup and recovery in laboratory settings, as well as in any other automated applications, implemented with planar motor systems. The present invention enhances the functionality of planar motor systems in cleanup and recovery operations by providing automation of several key elements. These include automating carriage fittings, which are specialized attachments fitted to movers or carriages (that connect, adapt, or adjust the movers or carriages) to enable the secure, adjustable, and often mobile support and manipulation of other laboratory equipment. Examples of fittings include tube carriages, adjustable holders, clamps and stands, and transfer carriages. Carriage fittings may also vary in form depending on the specific task, such as for example brushes for sweeping debris or small items off the stator surface, squeegees for collecting and directing liquids toward catchment devices, shovels or pushers for moving larger debris or misplaced items, vacuums and blowers for suctioning or blowing away particles, dust, and liquids, magnetic or adhesive pads for picking up metal objects or small parts, and spinning or fixed mopping pads that provide thorough cleaning of the planar motor surface in the event of spills or the like. Regardless of type, application of the present invention to carriage fittings, in addition to carriages themselves and other devices, enables recovery and cleanup operations on the planar motor surface and also on the stators themselves.

Carriage fittings or attachments may receive power inductively through stator magnetic fields, wirelessly, via wires, or through self-contained systems such as batteries. Utility supplies such as air pressure, vacuum, or liquids can be generated on the carriage via pumps, supplied through wires, or stored in onboard reservoirs. Carriages may also carry cleaning agents, disinfectants, or other materials necessary for the cleanup process.

Movers or carriages may be equipped with multiple fittings to allow various operation modes. For instance, a carriage may have both a brush and a squeegee attachment, which can be engaged either by adjusting the tilt angle of the carriage or through mechanical actuation.

They also include catchment devices installed at strategic locations to interact with the carriage fittings, facilitating the cleanup and recovery of materials, items, and debris from the planar motor surface and stators. Catchment devices are installed at strategic locations on the planar motor surface to assist in the removal of materials, items, debris, liquids, or other impediments to processing. These devices come in different forms, including simple catch bins, which are passive containers that collect debris, materials, or liquids, electromechanical devices that are active systems with actuated blades or conveyors to collect debris, vacuum manifolds that suction liquids, dust, or small particles into waste containers, and waste disposal interfaces that transfer collected waste into appropriate disposal systems, such as recycling bins or hazardous waste containers.

In this embodiment, a combination of sensors and software is used to detect errors or issues in a monitoring and detection system. This includes a control mechanism that responds to detected errors by orchestrating recovery and corrective actions without significantly interrupting the primary processing workflow. The present invention therefore provides enhancements that enable a comprehensive solution where planar motor systems are applied in operating environments such as laboratory automation, to automatically detect and resolve issues such as spills, dropped items, debris, and equipment malfunctions. The present invention improves efficiency, reduces downtime, and maintains optimal operational conditions across a range of automated applications including manufacturing, logistics, warehousing, and laboratory automation.

In the monitoring and detection system utilizes sensors and algorithms to detect issues within the planar motor system. A variety of sensors and technologies may be utilized, including vision or imaging systems, infrared sensors that detect heat signatures, spills, or overheating components, light and reflective sensors, time-of-flight sensors that measure distances and detect obstructions, acoustic sensors, weight sensors, and chemical sensors that detect specific substances or hazardous materials.

Cleanup and recovery functionalities enabled by the present invention include error evaluation for analyzing detected issues to determine appropriate responses, process orchestration for executing cleanup or recovery routines in conjunction with ongoing processes, decision-making that utilizes rule-based logic, real-time feedback, thresholds, additional artificial intelligence and machine learning algorithms to adapt to new situations that arise when cleanup and recovery is required, and maintenance scheduling where routine and periodic cleanup and maintenance tasks are to be performed.

In this embodiment, an exemplary operational workflow for cleanup and recovery may

begin when an error or issue is determined from the monitoring and detection system. The detection may trigger the following sequence: the monitoring system identifies an issue, and alerts a control system that evaluates the issue and determines the appropriate response. The present invention then initiates and executes a responsive action (for example, in a specially-configured workflow agent 140), in which carriages with the necessary fittings are dispatched to perform cleanup or recovery operations. Once completed, the primary processing workflow resumes. These may occur in parallel with cleanup operations if permitted according to pre-identified constraints.

Cleanup and recovery operations may be applied across various industries and workflows. Below are examples of how such operations may be applied in different settings.

Example 1: Manufacturing Assembly Line Debris Removal. In a manufacturing environment, small parts or packaging materials may fall onto the planar motor surface, causing obstructions in the assembly line. Sensors detect foreign objects or debris, a control system is alerted, and a carriage with a brush or pusher attachment is dispatched to move the debris into a catchment bin. The assembly line continues operations with minimal interruption.

Example 2: Logistics Center Spill Management. In a logistics center using planar motors for automated sorting, a container may leak, spilling its contents onto the processing surface. Liquid sensors or vision systems identify the spill, triggering a control system to initiate safety protocols. A carriage with a squeegee and vacuum attachment is dispatched to clean up the spill, and an air blower may be deployed to dry the surface before operations resume.

Example 3: Warehouse Item Misplacement Correction. In a warehouse, items may be incorrectly placed or fall off carriages, leading to inventory errors or processing delays. Vision systems detect misplaced items, and a carriage equipped with a robotic arm or gripper attachment is dispatched to pick up the item and place it onto the appropriate carriage or into a designated area.

Example 4: Laboratory Automation—Pipette Tip Recovery. Returning to an automated laboratory environment, in a further example disposable pipette tips may be misloaded or dropped onto the processing surface. High-resolution cameras detect scattered tips, and a specialized carriage is dispatched to collect them into a biohazardous waste bin. Operations resume once the surface is clear.

Example 5: Food Processing Line Contamination Control. In a food processing plant, spills of food particles or liquids onto the planar motor surface can pose contamination risks. Sensors detect the presence of contaminants, and a carriage with a sanitary-grade squeegee and mop attachment is dispatched to clean and sanitize the area. Normal operations resume once industry hygiene standards are met.

Regardless of operational environment, the cleanup and recovery aspect of the present invention provides enhanced functionality as it adds cleanup and recovery capabilities without altering the fundamental planar motor system upon which devices and movers are being operated. This embodiment provides automated processes that reduce manual intervention, lower labor costs, and minimize human exposure to hazards. It also allows for cleanup and recovery operations to occur without significant disruption to primary processes, ensures adherence to industry regulations and standards, and seamlessly integrates with various sizes and configurations of planar motor systems.

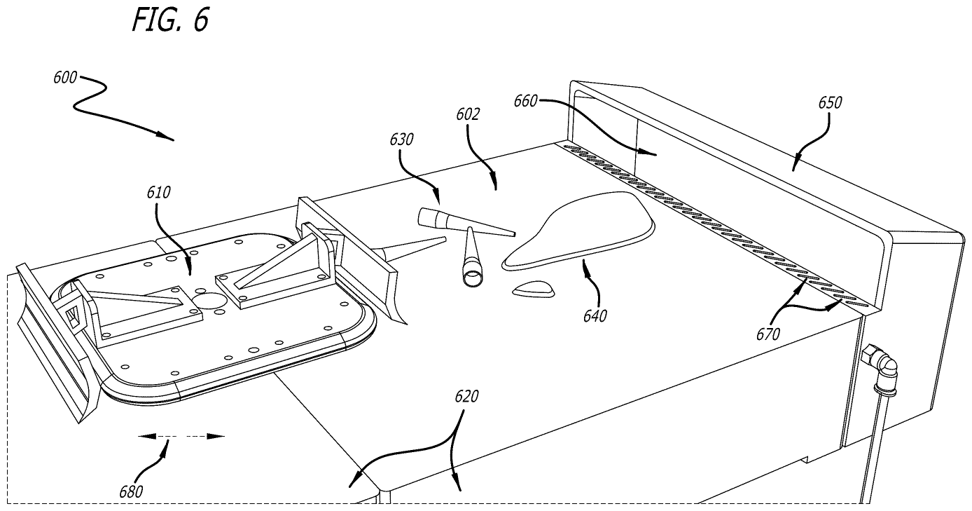

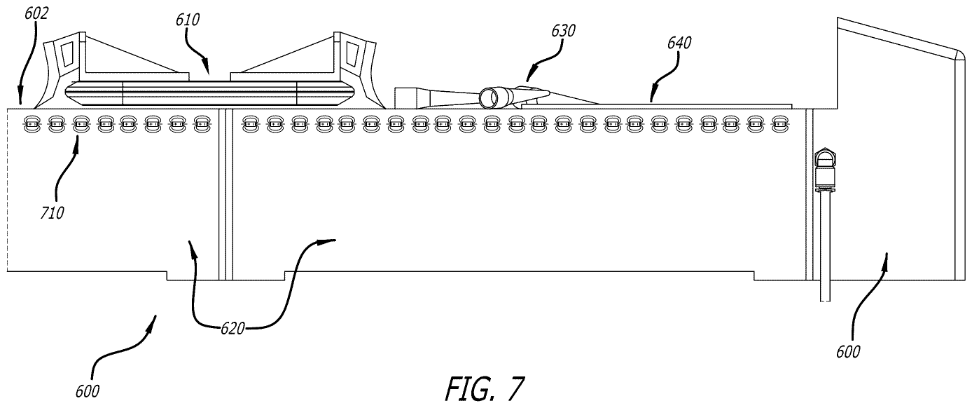

FIG. 6 and FIG. 7 each illustrate a different views of an exemplary deployment of a planar motor system in a laboratory automation environment in a cleanup and recovery embodiment of the present invention. FIG. 6 is a perspective view of a system for planar motor transport 600 of such a deployment, while FIG. 7 is a side view of a system for planar motor transport 600 thereof.

In FIG. 6, a cleanup module 610 is positioned atop a planar motor surface 602 of a planar motor transport 600 that is also comprised of planar motor stators 620 (or tiles). FIG. 6 illustrates both dry waste 630 and liquid waste 640, and waste receptacle 650 with a debris port 660 for dry waste 630, and aspirator ports 670 for liquid waste 640. The cleanup module 610 moves in planar directions 680 as governed by the stators 620 and magnets 710 of the system for planar motor transport 600.

FIG. 7 illustrates these magnets 710 in the system for planar motor transport 600. The cleanup module 610 is positioned atop the planar motor surface 602, and dry waste 630 and liquid waste 640 are also present on the planar motor surface 602. As shown in FIG. 7, the planar motor stators 620 generate an electromagnetic field to provide lift and horizontal motion to the cleanup module 610 through the magnets 710, allowing the cleanup module to magnetically levitate just above the planar motor surface 610. FIG. 7 also shows the waste receptacle 650.

Access to the distributed control architecture 100 of the present invention may be provided through one or more application programming interfaces (APIs) for functions such as communications with third-party software applications. APIs may be provided for particular forms of output data generated by the present invention, such as, e.g., reporting on error detection and cleanup and recovery operations. Third parties, for example, may utilize such APIs to develop their own, follow-on uses of output data, such as to generate and export customized reports or alerts, provide updates to one or more software applications, modify one or more third-party instruments, or develop their own enterprise-specific applications.

It is to be understood, as noted above, that the present invention is not to be limited to any particular type of automation environment, and that the present invention may be applied to any field where automated control of instruments and/or tasks performed by such instruments is desired. For example, the present invention may be for packaging and shipping, such as where instruments are used to identify an item to be shipped, prepare the item within a package for shipment, and scheduling a shipment of the package. Many types of workflows and workflow agents 140 are therefore possible and are within the scope of the present invention.

The systems and methods of the present invention may be implemented in many different computing environments. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, GPU and any comparable means. Still further, the present invention may be implemented in cloud-based data processing environments, and where one or more types of servers are used to process large amounts of data, and using processing components such as CPUs, GPUs, TPUs, and other similar hardware. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors or general processing units), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be wholly or partially implemented in software that can be stored on a non-transitory computer-readable storage medium, executed on programmed general-purpose computer with the cooperation of a controller and memory, a special purpose computer, a microprocessor, or the like. In these instances, the systems and methods of this invention can be implemented as a program embedded on a mobile device or personal computer through such mediums as an applet, JAVA® or CGI script, as a resource residing on one or more servers or computer workstations, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, machine learning, artificial intelligence, fuzzy logic, expert system or combination of hardware and software that is capable of performing the data processing functionality described herein.

Aspects of the present specification can also be described by the following embodiments:
1. A system, comprising: a planar motor transport configured in a laboratory environment in which automated laboratory functions are automatically executed; one or more movers positioned on a planar motor surface and configured to execute the automated laboratory functions in x, y, and z directions defined by the planar motor transport, the one or more movers having devices configured with the one or more movers for processing, handling, and moving laboratory samples; and a distributed control architecture that controls an operation of the one or more movers along the x, y and z directions defined by the planar motor transport, and an operation of the devices configured with the one or more movers, the distributed control architecture having an autonomous execution layer that coordinates individual workflow instances in the automated laboratory functions that are performed by one or more workflow agents, and a time-based reservation management layer that performs a temporal conflict check, and creates temporal reservations for one or more movers having devices configured for processing, handling, and moving laboratory samples.
2. The system of embodiment 1, wherein the planar motor transport is driven by one or more planar motor stators and a series of magnets that enable the one or more movers to magnetically levitate above the planar motor surface and operate the one or more movers in the x, y, and z directions.
3. The system of embodiment 1 or 2, wherein the distributed control architecture includes a queue priority manager that integrates input data from a device manager and a mover manager, the input data at least including an order, device information, mover information, and temporal information for the order for the one or more workflow agents.
4. The system of any one of embodiments 1-3, wherein the autonomous execution layer comprises workflow agent execution logic and a transport and execute process that identify the individual workflow instances for each order and control the performance of the one or more workflow agents.
5. The system of any one of embodiments 1-4, wherein the automated laboratory functions include in-situ pipetting of the laboratory samples performed by a multi-channel pipetting head mounted on a hovering labware shuttle above the planar motor surface.
6. The system of any one of embodiments 1-5, wherein the automated laboratory functions include bulk reagent dispensing of the laboratory samples on a hovering labware shuttle above the planar motor surface.
7. The system of any one of embodiments 1-6, wherein the automated laboratory functions include cleanup of spilled laboratory samples using a hovering labware shuttle above the planar motor surface, and recovery of the one or more workflow agents following the cleanup.
8. A method, comprising: ingesting input data that at least includes an order, device information, mover information, and temporal information for the order, into a system for automatically executing automated laboratory functions using a planar motor transport; processing the input data within a distributed control architecture that performs a temporal conflict check, creates temporal reservations for one or more movers having devices configured for processing, handling, and moving laboratory samples, and authorizes execution of the order; creating one or more workflow agents for executing the order; and executing the order on a planar motor surface of the planar motor transport, wherein the distributed control architecture controls an operation of the one or more movers along the x, y and z directions defined by the planar motor transport, and an operation of the devices configured with the one or more movers, to execute the order, the distributed control architecture having an autonomous execution layer that coordinates individual workflow instances in the automated laboratory functions that are performed by the one or more workflow agents.
9. The method of embodiment 8, wherein the planar motor transport is driven by one or more planar motor stators and a series of magnets that enable the one or more movers to magnetically levitate above the planar motor surface and operate the one or more movers in the x, y, and z directions.
10. The method of embodiment 8 or 9, wherein the distributed control architecture includes a queue priority manager that integrates input data from a device manager and a mover manager, the input data at least including an order, device information, mover information, and temporal information for the order for the one or more workflow agents.
11. The method of any one of embodiments 8-10, wherein the autonomous execution layer comprises workflow agent execution logic and a transport and execute process that identify the individual workflow instances for each order and control the performance of the one or more workflow agents.
12. The method of any one of embodiments 8-11, wherein the automated laboratory functions include in-situ pipetting of the laboratory samples performed by a multi-channel pipetting head mounted on a hovering labware shuttle above the planar motor surface.
13. The method of any one of embodiments 8-12, wherein the automated laboratory functions include bulk reagent dispensing of the laboratory samples on a hovering labware shuttle above the planar motor surface.
14. The method of any one of embodiments 8-13, wherein the automated laboratory functions include cleanup of spilled laboratory samples using a hovering labware shuttle above the planar motor surface, and recovery of the one or more workflow agents following the cleanup.
15. A method, comprising: analyzing, within a distributed control architecture, information relative to automatically executing automated laboratory functions, the information at least including at least includes an order, device information, mover information, and temporal information for the order, wherein the automated laboratory functions are performed using a planar motor transport having a planar motor surface above which one or more hovering labware shuttles acting as movers are positioned, wherein the distributed control architecture performs a temporal conflict check, creates temporal reservations for one or more movers having devices configured for processing, handling, and moving laboratory samples, and authorizes execution of the order; instantiating one or more workflow agents that are configured to automatically execute the order in a plurality of workflow instances; and controlling an operation of the one or more movers along the x, y and z directions defined by the planar motor transport, and an operation of the devices configured with the one or more movers, in an autonomous execution layer that coordinates the plurality of individual workflow instances to perform the automated laboratory functions.
16. The method of embodiment 15, wherein the planar motor transport is driven by one or more planar motor stators and a series of magnets that enable the one or more movers to magnetically levitate above the planar motor surface and operate the one or more movers in the x, y, and z directions.
17. The method of embodiment 15 or 16, wherein the distributed control architecture includes a queue priority manager that integrates input data from a device manager and a mover manager, the input data at least including an order, device information, mover information, and temporal information for the order for the one or more workflow agents.
18. The method of any one of embodiments 15-17, wherein the autonomous execution layer comprises workflow agent execution logic and a transport and execute process that identify the individual workflow instances for each order and control the performance of the one or more workflow agents.
19. The method of any one of embodiments 15-18, wherein the automated laboratory functions include in-situ pipetting of the laboratory samples performed by a multi-channel pipetting head mounted on a hovering labware shuttle above the planar motor surface.
20. The method of any one of embodiments 15-19, wherein the automated laboratory functions include bulk reagent dispensing of the laboratory samples on a hovering labware shuttle above the planar motor surface.
21. The method of any one of embodiments 15-20, wherein the automated laboratory functions include cleanup of spilled laboratory samples using a hovering labware shuttle above the planar motor surface, and recovery of the one or more workflow agents following the cleanup.

In closing, foregoing descriptions of embodiments of the present invention have been presented for the purposes of illustration and description. It is to be understood that, although aspects of the present invention are highlighted by referring to specific embodiments, one skilled in the art will readily appreciate that these described embodiments are only illustrative of the principles comprising the present invention. As such, the specific embodiments are not intended to be exhaustive or to limit the invention to the precise forms disclosed. Therefore, it should be understood that embodiments of the disclosed subject matter are in no way limited to a particular element, compound, composition, component, article, apparatus, methodology, use, protocol, step, and/or limitation described herein, unless expressly stated as such.

In addition, groupings of alternative embodiments, elements, steps and/or limitations of the present invention are not to be construed as limitations. Each such grouping may be referred to and claimed individually or in any combination with other groupings disclosed herein. It is anticipated that one or more alternative embodiments, elements, steps and/or limitations of a grouping may be included in, or deleted from, the grouping for reasons of convenience and/or patentability. When any such inclusion or deletion occurs, the specification is deemed to contain the grouping as modified, thus fulfilling the written description of all Markush groups used in the appended claims.

Furthermore, those of ordinary skill in the art will recognize that certain changes, modifications, permutations, alterations, additions, subtractions, and sub-combinations thereof can be made in accordance with the teachings herein without departing from the spirit of the present invention. Furthermore, it is intended that the following appended claims and claims hereafter introduced are interpreted to include all such changes, modifications, permutations, alterations, additions, subtractions, and sub-combinations as are within their true spirit and scope. Accordingly, the scope of the present invention is not to be limited to that precisely as shown and described by this specification.

Certain embodiments of the present invention are described herein, including the best mode known to the inventors for conducting the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

The words, language, and terminology used in this specification is for the purpose of describing particular embodiments, elements, steps and/or limitations only and is not intended to limit the scope of the present invention, which is defined solely by the claims. In addition, such words, language, and terminology are to be understood not only in the sense of their commonly defined meanings, but to include by special definition in this specification structure, material or acts beyond the scope of the commonly defined meanings. Thus, if an element, step or limitation can be understood in the context of this specification as including more than one meaning, then its use in a claim must be understood as being generic to all possible meanings supported by the specification and by the word itself.

The definitions and meanings of the elements, steps or limitations recited in a claim set forth below are, therefore, defined in this specification to include not only the combination of elements, steps or limitations which are literally set forth, but all equivalent structure, material or acts for performing substantially the same function in substantially the same way to obtain substantially the same result. In this sense it is therefore contemplated that an equivalent substitution of two or more elements, steps and/or limitations may be made for any one of the elements, steps or limitations in a claim set forth below or that a single element, step, or limitation may be substituted for two or more elements, steps and/or limitations in such a claim. Although elements, steps or limitations may be described above as acting in certain combinations and even initially claimed as such, it is to be expressly understood that one or more elements, steps and/or limitations from a claimed combination can in some cases be excised from the combination and that the claimed combination may be directed to a sub-combination or variation of a sub-combination. As such, notwithstanding the fact that the elements, steps and/or limitations of a claim are set forth below in a certain combination, it must be expressly understood that the invention includes other combinations of fewer, more, or different elements, steps and/or limitations, which are disclosed in above combination even when not initially claimed in such combinations. Furthermore, insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Accordingly, the claims are thus to be understood to include what is specifically illustrated and described above, what is conceptually equivalent, what can be obviously substituted and also what essentially incorporates the essential idea of the invention.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a comparable manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as, e.g., “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as, e.g., “comprise” and “comprises”, and equivalent open-ended transitional phrases thereof like “including”, “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement, and support for the phrases “consisting essentially of” and “consisting of.”

Lastly, all patents, patent publications, and other references cited and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. The reference to any prior art in this specification is not, and should not be taken as, an acknowledgement or any form of suggestion that the prior art forms part of the common general knowledge from any country. In addition, nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

1. A system, comprising:
a planar motor transport configured in a laboratory environment in which automated laboratory functions are automatically executed;
one or more movers positioned on a planar motor surface and configured to execute the automated laboratory functions in x, y, and z directions defined by the planar motor transport, the one or more movers having devices configured with the one or more movers for processing, handling, and moving laboratory samples; and
a distributed control architecture that controls an operation of the one or more movers along the x, y and z directions defined by the planar motor transport, and an operation of the devices configured with the one or more movers, the distributed control architecture having an autonomous execution layer that coordinates individual workflow instances in the automated laboratory functions that are performed by one or more workflow agents, and a time-based reservation management layer that performs a temporal conflict check, and creates temporal reservations for one or more movers having devices configured for processing, handling, and moving laboratory samples.

2. The system of claim 1, wherein the planar motor transport is driven by one or more planar motor stators and a series of magnets that enable the one or more movers to magnetically levitate above the planar motor surface and operate the one or more movers in the x, y, and z directions.

3. The system of claim 1, wherein the distributed control architecture includes a queue priority manager that integrates input data from a device manager and a mover manager, the input data at least including an order, device information, mover information, and temporal information for the order for the one or more workflow agents.

4. The system of claim 1, wherein the autonomous execution layer comprises workflow agent execution logic and a transport and execute process that identify the individual workflow instances for each order and control the performance of the one or more workflow agents.

5. The system of claim 1, wherein the automated laboratory functions include in-situ pipetting of the laboratory samples performed by a multi-channel pipetting head mounted on a hovering labware shuttle above the planar motor surface.

6. The system of claim 1, wherein the automated laboratory functions include bulk reagent dispensing of the laboratory samples on a hovering labware shuttle above the planar motor surface.

7. The system of claim 1, wherein the automated laboratory functions include cleanup of spilled laboratory samples using a hovering labware shuttle above the planar motor surface, and recovery of the one or more workflow agents following the cleanup.

8. A method, comprising:
ingesting input data that at least includes an order, device information, mover information, and temporal information for the order, into a system for automatically executing automated laboratory functions using a planar motor transport;
processing the input data within a distributed control architecture that performs a temporal conflict check, creates temporal reservations for one or more movers having devices configured for processing, handling, and moving laboratory samples, and authorizes execution of the order;
creating one or more workflow agents for executing the order; and
executing the order on a planar motor surface of the planar motor transport,
wherein the distributed control architecture controls an operation of the one or more movers along the x, y and z directions defined by the planar motor transport, and an operation of the devices configured with the one or more movers, to execute the order, the distributed control architecture having an autonomous execution layer that coordinates individual workflow instances in the automated laboratory functions that are performed by the one or more workflow agents.

9. The method of claim 8, wherein the planar motor transport is driven by one or more planar motor stators and a series of magnets that enable the one or more movers to magnetically levitate above the planar motor surface and operate the one or more movers in the x, y, and z directions.

10. The method of claim 8, wherein the distributed control architecture includes a queue priority manager that integrates input data from a device manager and a mover manager, the input data at least including an order, device information, mover information, and temporal information for the order for the one or more workflow agents.

11. The method of claim 8, wherein the autonomous execution layer comprises workflow agent execution logic and a transport and execute process that identify the individual workflow instances for each order and control the performance of the one or more workflow agents.

12. The method of claim 8, wherein the automated laboratory functions include in-situ pipetting of the laboratory samples performed by a multi-channel pipetting head mounted on a hovering labware shuttle above the planar motor surface.

13. The method of claim 8, wherein the automated laboratory functions include bulk reagent dispensing of the laboratory samples on a hovering labware shuttle above the planar motor surface.

14. The method of claim 8, wherein the automated laboratory functions include cleanup of spilled laboratory samples using a hovering labware shuttle above the planar motor surface, and recovery of the one or more workflow agents following the cleanup.

15. A method, comprising:
analyzing, within a distributed control architecture, information relative to automatically executing automated laboratory functions, the information at least including at least includes an order, device information, mover information, and temporal information for the order, wherein the automated laboratory functions are performed using a planar motor transport having a planar motor surface above which one or more hovering labware shuttles acting as movers are positioned, wherein the distributed control architecture performs a temporal conflict check, creates temporal reservations for one or more movers having devices configured for processing, handling, and moving laboratory samples, and authorizes execution of the order;
instantiating one or more workflow agents that are configured to automatically execute the order in a plurality of workflow instances; and
controlling an operation of the one or more movers along the x, y and z directions defined by the planar motor transport, and an operation of the devices configured with the one or more movers, in an autonomous execution layer that coordinates the plurality of individual workflow instances to perform the automated laboratory functions.

16. The method of claim 15, wherein the planar motor transport is driven by one or more planar motor stators and a series of magnets that enable the one or more movers to magnetically levitate above the planar motor surface and operate the one or more movers in the x, y, and z directions.

17. The method of claim 15, wherein the distributed control architecture includes a queue priority manager that integrates input data from a device manager and a mover manager, the input data at least including an order, device information, mover information, and temporal information for the order for the one or more workflow agents.

18. The method of claim 15, wherein the autonomous execution layer comprises workflow agent execution logic and a transport and execute process that identify the individual workflow instances for each order and control the performance of the one or more workflow agents.

19. The method of claim 15, wherein the automated laboratory functions include in-situ pipetting of the laboratory samples performed by a multi-channel pipetting head mounted on a hovering labware shuttle above the planar motor surface.

20. The method of claim 15, wherein the automated laboratory functions include bulk reagent dispensing of the laboratory samples on a hovering labware shuttle above the planar motor surface.

21. The method of claim 15, wherein the automated laboratory functions include cleanup of spilled laboratory samples using a hovering labware shuttle above the planar motor surface, and recovery of the one or more workflow agents following the cleanup.
